(19) United States
(12) Patent Application Publication
(10) Pub. No.: US 2013/0155464 A1
(43) Pub. Date: Jun. 20, 2013

(54) PRINT APPLICATION

(71) Applicant: Christopher Alan Bearchell, Garsington (GB)

(72) Inventor: Christopher Alan Bearchell, Garsington (GB)

(21) Appl. No.: 13/817,504

(22) PCT Filed: Aug. 19, 2011
(86) PCT No.: PCT/GB2011/001243

§ 371 Date: Feb. 18, 2013

(30) Foreign Application Priority Data
Aug. 19, 2010 (GB) 1013902.0

(51) Int. Cl. G06K 15/02

(52) U.S. Cl. CPC G06K 15/181
USPC 358/1.15

(57) ABSTRACT

A print engine is disclosed comprising a discovery module and a number of content formatters. When a document is to be printed a content formatter is selected based on the format of the document. The document is then analysed together with capabilities data obtained by the discovery module to determine whether the document is in a format compatible with the capabilities of the printer to be used to print the document. If this is the case the unprocessed document is passed to the printer. If the document is not in a format compatible with the capabilities of the printer, the print engine determines whether the document can be modified to remove incompatibilities between the format of the document and a format compatible with the capabilities of the printer without removing content from the document and if so modifies the document and passes the processed document to the printer.

### FIELD OF THE INVENTION

The present application relates to a print application. More specifically embodiments of the present application relate to print applications for use with mobile devices such as cellular mobile phones.

### BACKGROUND TO THE INVENTION

Cellular mobile phones have begun to take the place of the personal digital assistant ‘PDA’. Traditionally, where users required a range of functions they needed to use a cellular mobile phone in conjunction with portable computers and/or a PDA. Nowadays, with advances in screen technology, e-mail services and Internet connectivity on cellular mobile phones, many of these functions can be achieved using just a phone.

Many different types of format file are used in modern computing. Typically, these may include word processing files, web page files, pdf (portable document format) files and image files such as jpeg, gif, png, bitmap etc., and may have been created on, or reside on, a computer or portable computer. Alternatively, the files may reside on a server from where they may be transmitted to a user over the Internet.

Although cellular mobile phone technology has progressed so that it is possible to view many different types of files directly on the display screen of a cellular mobile phone, it is often still desirable to print files for viewing as hard copy. This can either be because of the display limitations of a cellular mobile phone make a file difficult to view or alternatively a hard copy may be desired for other reasons such as for off-line editing or a file may need to be printed out to be physically handed over to someone else.

Conventionally in the case of a computer or portable computer, when a user wishes to print a file, an application running on the computer generates a file in a format specific to the application program and sends the file in to a printer driver installed on the computer. The printer driver translates the file from its application specific format to printer-interpretable data in a format which is understandable by a particular printer or class of printers. This printer-interpretable data is known as a print job. Once a print job has been created by the computer, it is then transmitted from the computer to a printer in the particular class of printers. When the printer receives the print job, the printer interprets the data included in the print job and prints a copy of the document.

Thus for example, a computer running a word processing application such as Microsoft Word® will generate Word data files typically indicated by a file extension .doc or .docx. When printing out such a document, the Word data file is passed to a printer driver installed on the computer. The printer driver converts the Word data in the form understandable by the word processor into a form of instructions understandable by the specific printer or range of printers associated with the printer driver and these instructions are then transmitted to a printer and used by the printer to print the document.

Compared with desktop or portable computers, mobile devices have considerable resource constraints with respect to storage capacity, processing speed and available power. Consequently, mobile device vendors do not ordinarily include in such devices, printer drivers to convert files in a form understandable by application programs into printer-interpretable data for specific printers or groups of printers.

Additionally, unlike desktop computers, mobile devices are frequently carried to new locations where users may wish to print out copies of documents. Memory constraints mean that it is not practical for a mobile device to store printer drivers for all printer types the mobile device may encounter. The functionality of printers at the new locations may or may not be supported by an installed printer driver. If the functionality of a printer is not supported a user needs to download a new printer driver to be able to use that printer which increases demands on bandwidth.

In view of the difficulties involved rather than providing printer drivers on mobile devices a number of alternative approaches have been undertaken.

One known approach is to send a file in its original format, such as a pdf or jpeg file, directly to a printer, with the printer then processing the file into printer-interpretable data. The main problem with such an approach is that it depends upon the capabilities of the available printer whether or not it is successful. It is possible that a printer which a user desires to use to print a file in a particular format may not be capable of rendering files in that format into printer-interpretable data and a print request will fail.

A second known approach is to send a file in its original format to a printer via a proxy, with the proxy processing the file into printer-interpretable data and transmitting the data to the printer (either directly e.g. if the printer is an Internet Printing Protocol ‘IPP’ printer, or via the mobile device). Such an approach reduces the possibility that the selected printer will be unable to process the dispatched file. However, this is at the cost of extraneous network traffic involved with transmitting data from a server to a user-selected printer via at least the user's mobile device and a proxy, and often via the user's mobile device once more.

An intermediate approach is disclosed in US2008/0158581. In US2008/0158581 a discovery operation is undertaken to determine the print languages and data formats that a printer can understand are determined prior to sending out a print job. When data is to be printed, before data is dispatched a check is made to determine if the data is in already in a format which will be understood by that printer. If that is the case, the data is incorporated into a print job and dispatched to the printer. If, however, it is determined that the data format will not be understood by the printer, the data is processed and converted into a set of print instructions in a print language identified as being understood by the printer and the converted data is incorporated in to a print job instead.

Thus for example in the case of a printer which was able to process say pdf files and PCL (Printer Command Language) but was not able to understand png (Portable Network Graphics) files, if a user asked for a pdf document to be printed out the pdf file would be incorporated into a print job without being processed. In contrast, if a user asked for a png file to be printed, it would be determined that the png file format was not compatible with the capabilities of the printer and the png file would be processed into a set of PCL instructions before being incorporated into a print job and being dispatched.

Although the approach US2008/0158581 facilitates printing using mobile devices alternative approaches are desirable.

### SUMMARY OF THE INVENTION

One aspect of the present invention provides a method of generating a print job for a printer. In accordance with this aspect, initially, the file and instruction formats which can be printed by a printer for which a print job is to be generated are determined. Subsequently, when a user identifies a document defining data for which a print job is to be generated, as a first step, the document is analyzed. If the document is in a format compatible with the capabilities of the printer, the unprocessed document is passed to the printer. If the document is not in a format compatible with the capabilities of the printer, a determination is made whether the document can be modified to remove incompatibilities between the format of the document and a format compatible with the capabilities of the printer without removing content from the document. If this is the case the determined modifications are made and the modified document is passed to the printer. If a document is not in a format compatible with the capabilities of the printer and cannot be modified without changing the content of the document to become compatible with the capabilities of the printer, the document is processed to generate print instructions compatible with the printer for representing the document and these print instructions are passed to the printer.

In some embodiments, the capabilities of a printer for which a print job is to be generated may be determined by performing a discovery operation to identify one or more available printers and capability data defining the capabilities of the printers discovered to be available may then be obtained.

Such capability data may comprise data defining: printer languages understood by the printer; document formats understandable by a printer; document format versions understandable by a printer; duplex capabilities (e.g. simplex, duplex long edge binding, duplex short edge binding); collation capabilities, supported paper sizes including data identifying paper dimensions and margins, printer output media supported (e.g. ink or toner), media path information (e.g. maximum paper width or height, minimum paper width or height), input trays, output trays and font data installed on a printer.

Typical printer languages would include languages such as: PostScript, Printer Command Language, Epson Standard Code for Printers, Ricoh Refined Printing Command Stream; Ricoh Printer driver language, XML Paper Specifications, ZJ stream, Canon Printing System Language, Xerox Escape Sequences, and XHTML-Print.

Suitable document formats which a printer might understand could include: Word Document format, Open Office word processing format, Excel format, Open Office spreadsheet format, Power point format, Open Office presentation format, jpeg format, png format, tiff format, gif format, e-mail message format, v-card contact format, android contact format, calendar entry format, pdf format, html format and text format.

In some embodiments, a determination of whether data is in a document format compatible with capabilities of a printer may involve identifying a file extension associated with a document to be printed to determine the format of the document and comparing the identified format with capability data for the printer identifying file formats compatible with the printer.

In some embodiments a file extension associated with a document may be utilized to determine the structure and syntax of document being processed. The determined structure and syntax of document may then be utilized when analyzing a document to determine whether the document is compatible with a format version identified by capability data as compatible with a printer to be utilized to print the document. If a document is not compatible with a format version identified by capability data, portions of the document which are not compatible with the identified format version may then be identified and modified or replaced.

In some embodiments if a document is not compatible with capability data for a printer, the document may be analyzed to determine portions of the document which are compatible with the capability data for a printer and data corresponding to the portions of a document identified as compatible with the capabilities of a printer may be passed to the printer without additional processing.

In some embodiments if a document is not compatible with capability data for a printer, portions of the document which correspond to images in a format identified as compatible with the capability data for a printer may be identified and passed to a printer without additional processing.

In some embodiments if a document is not compatible with capability data for a printer, the document may be analyzed to determine portions of the document which correspond to text in a format identified as compatible with the capability data for a printer and data corresponding to the portions of a document identified as compatible with the capabilities of a printer may be passed to a printer without additional processing.

In some embodiments a font for printing portions of a document identified as being text may be selected on the basis of capability data indicating fonts installed on the printer to be utilized to print the document.

In some embodiments font data identifying fonts installed on a printer may be derived indirectly from identification that a printer supports particular groups of fonts (e.g. by identifying PDL version support indicating support of Postscript level 1, 2 or 3 fonts).

In some embodiments if a document is not in a format identified as being compatible with a printer and the document cannot be processed to become compatible with the printer, the document may be processed by identifying a printer language compatible with the printer; selecting a printer driver to convert the pre-processed document into print instructions on the basis of the identified printer language; converting the pre-processed document using the selected printer driver to generate print instructions in the selected printer language; and outputting the generated print instructions.

Processing the document to generate print instructions compatible with the printer for representing the document may include determining whether print instructions compatible with the determined capabilities for a printer can be generated locally and if not sending the document for processing on a remote server.

In accordance with another aspect of the present invention there is provided a print engine comprising: a discovery module operable to determine the capabilities of a printer for which a print job is to be generated, wherein said capabilities define file and instruction formats which can be printed by the printer; and a content formatter operable to process a document defining data for which a print job is to be generated by: analyzing the document to determine whether the document is in a format compatible with the capabilities of the printer and if so passing the unprocessed document to the printer; if the document is not in a format compatible with the capabilities of the printer, determining whether the document can be modified to remove incompatibilities between the format of the document and a format compatible with the capabilities of the printer without removing content from the document and if so making the determined modifications and passing the processed document to the printer; and if a document is not in a format compatible with the capabilities of the printer and cannot be modified without changing the content of the document to become compatible with the capabilities of the printer, processing the document to generate print instructions compatible with the printer for representing the document and passing the generated instructions to the printer.

In some embodiments the print engine may additionally comprise a content identifier operable to identify a file extension associated with a document to printed wherein the content formatter comprises a plurality of content formatters each associated with a different file type wherein the print engine is operable to select a content formatter for processing a document to be processed on the basis of the file type identified by the content identifier.

In some embodiments the print engine may also include a plurality of printer drivers operable to convert processed documents into print instructions in a specific printer language. The print engine may be configured to determine on the basis of capabilities of a printer identified by the discovery module whether any of the plurality of printer drivers is operable to generate print instructions compatible with the printer and select a printer driver to generate print instructions on the basis of said determination wherein if the print engine determines that print instructions compatible with the determined capabilities for a printer cannot be generated by the print engine, the print engine is operable to send a document for processing on a remote server.

### DESCRIPTION OF THE DRAWINGS

Embodiments of the present invention will now be described with reference to the accompanying drawings in which:

FIG. 1 shows an overview of a system for printing from a mobile device including a print engine in accordance with an embodiment of the present invention;

FIG. 2 is a schematic block diagram of the print engine of FIG. 1;

FIG. 3 is a flow diagram of the processing undertaken by the print engine of FIG. 1;

FIG. 4 is an illustrative example of a portion of an xml file detailing the capabilities of an exemplary printer;

FIGS. 5A and 5B are an illustration of font substitution for an exemplary printer; and

FIGS. 6A and 6B are an illustrative example of the decomposition of an image into a number of constituent parts to facilitate opacity flattening and alpha channel data replacement.

### SPECIFIC DESCRIPTION

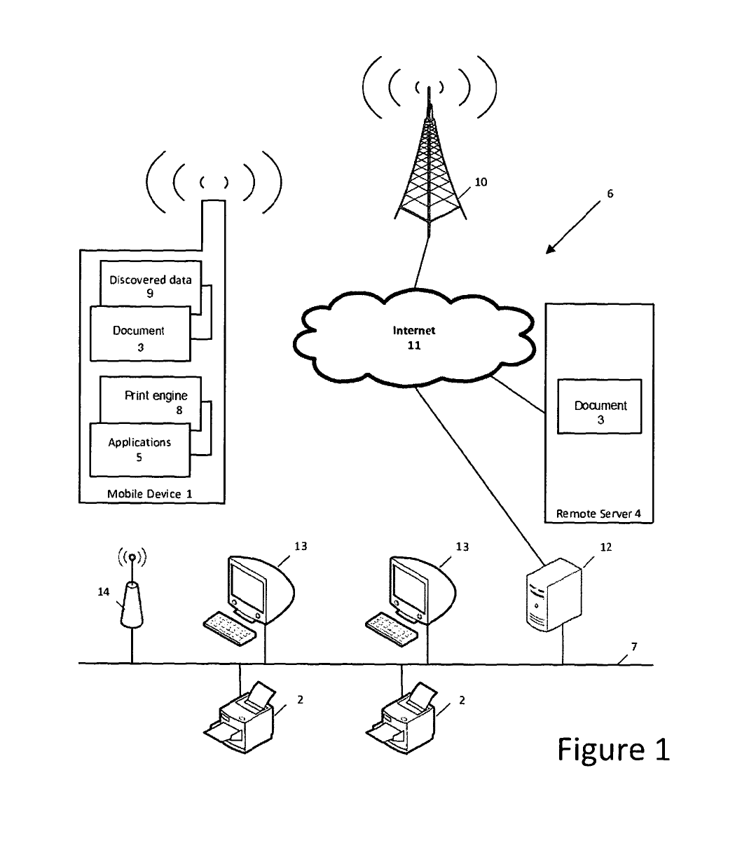

FIG. 1 a communication system in which a mobile device 1 such as a mobile cellular phone is provided which enables a user to cause a printer 2 to print out documents 3 either stored within the memory of the mobile device 1 or stored in the memory a remote server 4. In addition to storing documents 3, the memory of the mobile device 1 also stores number of applications 5. These applications 5 provide the mobile device 1 with standard capabilities including, e.g., Internet browsing, sending and receiving e-mails, WiFi/WLAN (hereafter referred to as WiFi) connectivity and Bluetooth connectivity. In this embodiment the mobile device 1 is arranged to access a communications network 6 which incorporates an Internet protocol ‘IP’ network 7 having printers 2 for printing out documents connected thereto.

In order to facilitate printing of the documents 3, a print engine 8 application is stored in the memory of the mobile device 1. As will be described the print engine 8 utilizes discovered data 9 detailing the capabilities of a printer 2 to be utilized to print a document 3 to determine the extent to which the content of a document 3 is compatible with the functionality of the printer 2 and if necessary modify aspects of a document 3 which are found to be incompatible with the functionality of the chosen printer 2.

In this embodiment, the communications network 6 includes a mast 10, the Internet 11 and one or more devices including printers 2, a gateway server 12, other computers 13, and the remote server 4 connected thereto. The mobile device 1 can be communicably linked via the mast 10 to either the Internet 11 or other mobile devices (not shown in FIG. 1) for making calls or exchanging data. Alternatively, mobile device 1 can be communicably linked to the IP network 7 via a network access point 14.

In the system shown in FIG. 1, the IP network 7 has connected thereto a number of personal computers ‘PCs’ 12, printers 2 and a gateway server 12 via which devices connected to the IP network 7 can connect to the Internet 11. Thus in use the mobile device 1 may be communicably linked to the remote server 4, via the IP network 7 or via the mast 10. The mobile device 1 can also be communicably linked to nearby (typically within 10 meters) devices such as printers 2 directly via Bluetooth.

When a user wishes to print a document 3, the print engine 8 initially determines whether the document 3 is already in a form which can be utilized by the printer 2 and if so the print engine 8 transmits the unmodified document to the printer 2 for printing.

If the print engine 8 determines that the document 3 is not already in a form which can be utilized by a printer 2, the print engine 8 then determines whether minor modifications of the document 3 would enable the document to be printed. Such minor modifications might involve deleting or replacing certain portions of the document 3 to remove inconsistencies between the identified capabilities of the printer 2 being utilized and the content of the document 2 to be printed. If it is determined that the document can be rendered compatible with the printer 2 by making minor modifications, the document 3 is processed to remove the incompatibilities and the print engine 8 transmits a slightly modified version of the document to the printer 2 for printing.

Typical processing might involve for example identifying fonts utilized in a document 3 and replacing fonts with similar fonts where a printer 2 did not support those fonts. Other examples might involve deleting sections of data for example thumb nail data for representing smaller version of an image defined by a document where such data is identified as not being understood by the selected printer 2. A further example would be removing alpha blend data from an image where a printer 2 was determined not to be able to interpret such data.

If a document 3 is not in a format compatible with a selected printer 2 and it is determined that making minor modifications to the document 3 would not address the incompatibilities, the print engine 8 converts the document 3 into print instructions in a language understandable by the printer 2 and these instructions are sent to the printer 2.

The checking of the compatibility of the capabilities of a printer 2 and the content of a document 3 in the way described facilitates printing in a manner which reduces the processing required by the mobile device 1 and enables documents 3 to be printed without excessive network traffic.

More specifically, if a printer 2 can be identified as having the capability to print a document 3 in a particular format, forwarding such a document 3 to a printer 2 without undertaking any modification avoids the need for a mobile device 1 to undertake any significant processing. Frequently, however, a document 3 may be in a format which is not entirely compatible with the known capabilities of a printer 2. Thus for example, capability data 9 for a printer 2 might identify that the printer 2 was capable of processing a certain version of pdf files. If a document 3 is determined to be a pdf document with a different version type, it may be the case that sending an unmodified version of the document 3 to the printer 2 would cause the printer 2 to fail to print correctly. However, often it is the case that the additional data which is included in a new version of a document format either is not actually present within a document or alternatively is not relevant to the printing of a document 3. By either removing such data or alternatively identifying that such additional data is not present a document 3 can be made or identified as being suitable for dispatch to a printer without a mobile device 1 having to convert the document 3 into a set of print instructions.

In addition to enabling documents 3 to be printed without having to convert the document 3 into a set of print instructions, such processing may also reduce the volume of data which needs to be dispatched to a printer 2. Thus for example where a printer 2 is not capable of undertaking alpha blending or a printer is identified as not having certain fonts installed, modifying a document to remove the need for the printer to undertake alpha blending or utilize uninstalled fonts may make a document 3 directly compatible with a printer 2 and at the same time reduce the size of a document 3 which is to be dispatched to a printer 2.

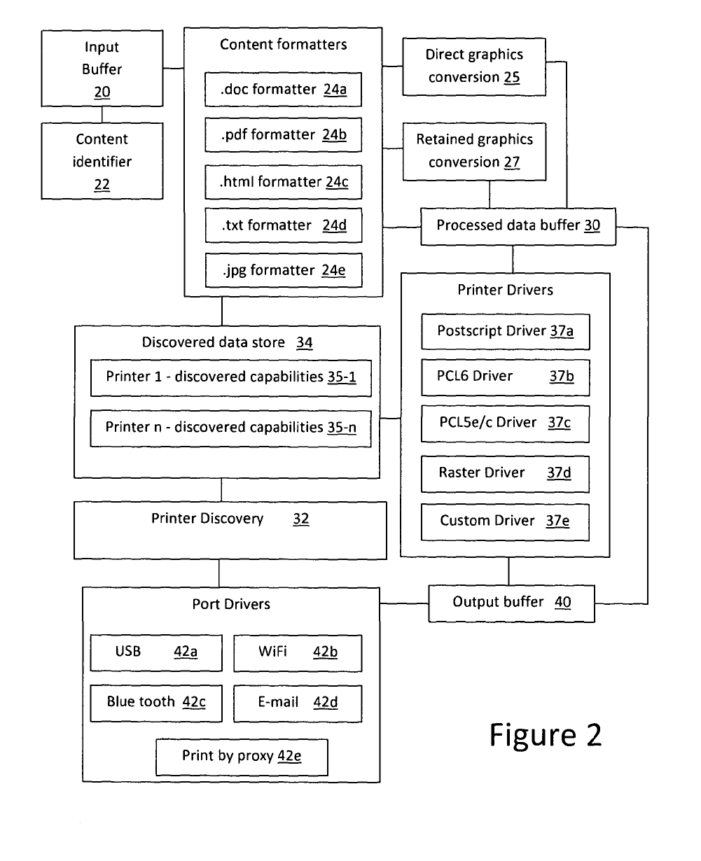

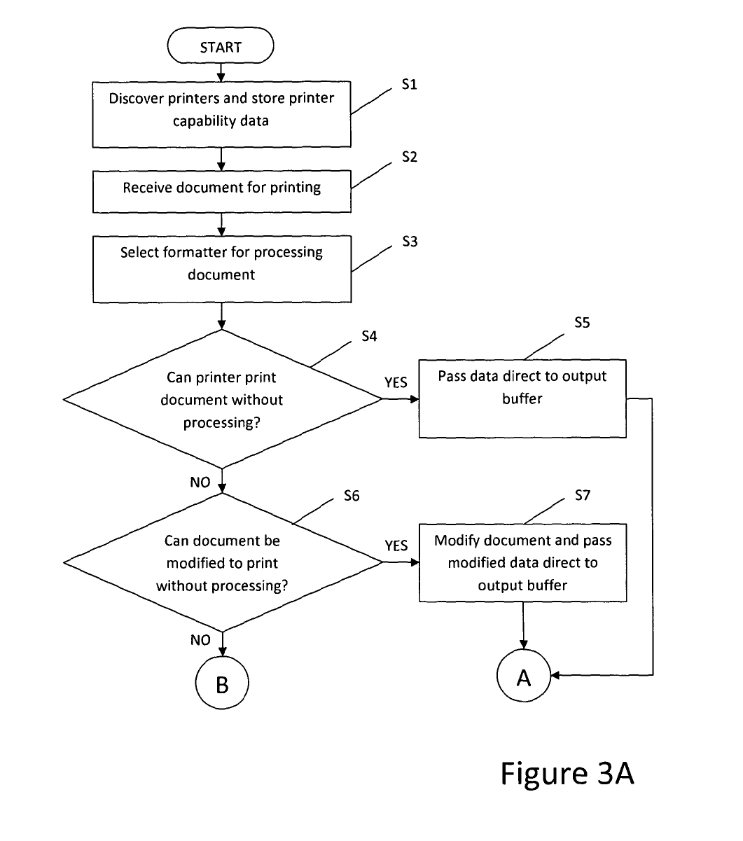

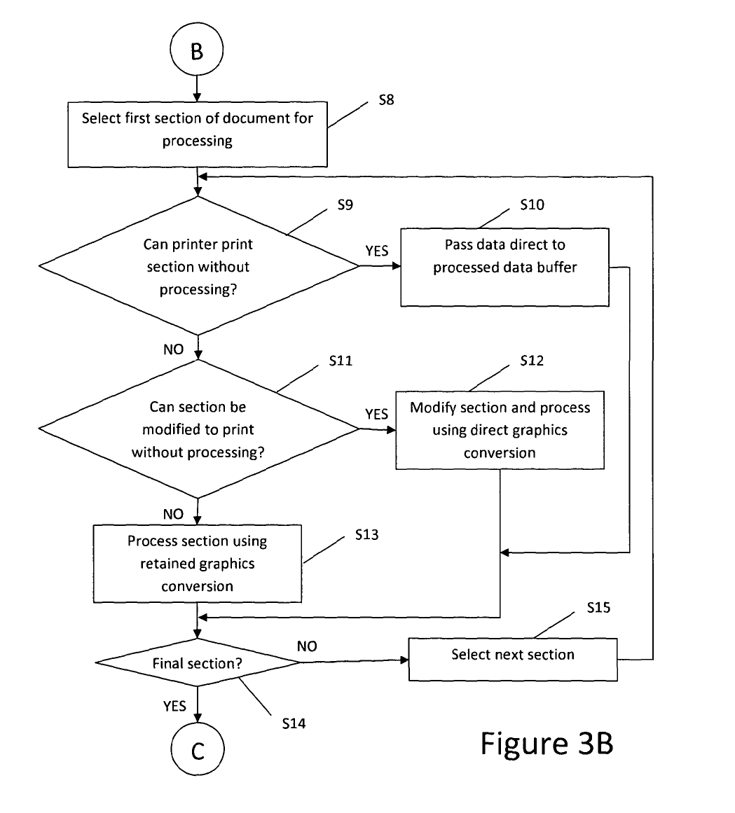

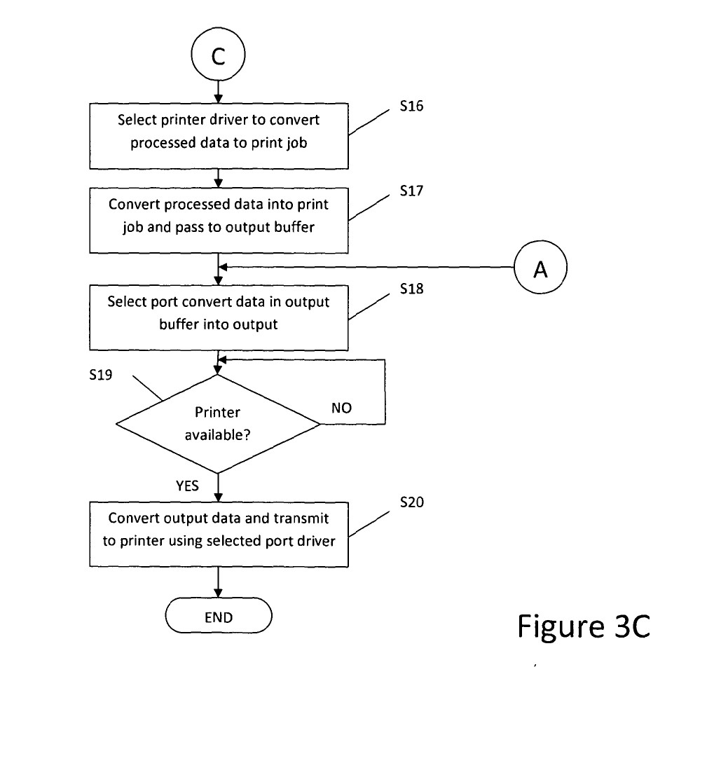

The structure and function of the print engine 8 will now be described in greater detail with reference to FIGS. 2 and 3 which are a schematic block diagram of the print engine 8 and a flow diagram of the processing undertaken by the print engine 8.

Referring to FIG. 2 in this embodiment the print engine 8 comprises an input buffer 20 for receiving documents 3 to be printed and a content identifier 22 which is operable to analyze the data stored in the input buffer 20 to identify a document type for a stored document.

Typical document formats might be Word documents, pdf documents, html documents, txt documents and jpeg documents. In the case of such document formats the type of a document to be printed can be identified by the file name extension for the document e.g. .doc, .pdf, .html, .txt, .jpg etc.

In addition to the input buffer 20 and the content identifier 22, the print engine 8 also comprises a set of content formatters 24a-24e, a direct graphics conversion module 25, a retained graphics conversion module 27 and a processed data buffer 30.

As will be explained later, once the content identifier 22 has identified a document 3 to be printed as being of a particular type, a content formatter 24a-24e is selected to process the document. The selected content formatter 24a-24e then proceeds to analyze the content of the document 3 to determine a minimal amount of processing required in order to convert the document 3 into a form suitable for generating print instructions for printing the document using a selected printer 2. As will be described, this analysis is undertaken both for the entire document 3 as a whole and for individual portions of the document 3. Depending upon the analysis the whole or parts of a document are either passed directly to the processed data buffer 30 or alternatively passed through either the direct graphics conversion module 25 or the retained graphics conversion module 27 which process portions of a document prior to storage in the processed data buffer 30.

More specifically, where a portion of a document 3 can be converted into a form suitable for printing using minimal processing such a portion of the document is passed to the direct graphics conversion module 25 which proceeds to convert that section of document into a suitable printable form.

Thus for example where a section of a document comprises text to be printed in a pre-installed font on a printer 2 the direct graphics conversion module 25 could process such a portion of document by copying the text to be printed and appending a suitable label identifying the font to be utilized. In contrast if the formatter 24a-24e identifies that a section of a document is such as to require detailed processing for example a portion of a document corresponding to an image requiring alpha blending, such a portion would be passed to the retained graphics conversion module 27 which would process that section of document to generate suitable printing instructions by for example converting an image undertaking rasterization, color matching and half toning etc.

In order that a selected content formatter 24a-24e can process a document appropriately, the print engine 8 must be aware of the capabilities of printer 2 being used to print the document 3. In order to obtain such information, the print engine 8 includes a printer discovery module 32 for performing a discovery operation and a discovered data store 34 for storing discovered capabilities data 35-1 . . . 35-n identifying the capabilities of discovered printers 2. Such discovered capabilities data 35-1 . . . 35-n would identify for each discovered printer 2 include amongst other things: its maximum printing resolution; whether it supports duplex, color, draft printing and the like; which, if any, file types it can render; the identity of an appropriate printer driver; whether it is an IPP printer; whether it is operable to receive print jobs by e-mail; the identity of any installed fonts etc. Other printer capabilities will be apparent to those skilled in the art.

Having processed a sections of a document 3 using the direct graphics conversion module 25 and the retained graphics conversion module 27 as appropriate, the data representing the document stored in the processed data buffer 30 is then converted into a print job for dispatch to the printer 2 using one of a set of printer drivers 37-a . . . 37-e.

In this embodiment, these printer drivers comprise: a postscript printer driver 37-a; a PCL6 printer driver 37-b; a PCL5e/c printer driver 37-c; a raster driver 37-d and one or more customer printer drivers 37-e. These printer drivers 37-a . . . 37-e comprise generic printer drivers for generating print job data in a variety of commonly used formats. The provision of a set of such printer drivers enables the print engine 8 is able to communicate with most printers 2. Where support for specific printer types is desired additional custom printer drivers 37-e could be stored.

The generated print job is then stored in an output buffer 40 before being transmitted to the selected printer 2 for printing. In this embodiment, data within the output buffer 40 is converted into a form suitable for transmission by one of a number of port drivers 42-a . . . 42-e corresponding to each of the various data transmission options available on the mobile device 1. In this embodiment these port drivers comprise a USB driver 42-a; a WiFi port driver 42-b; a Blue tooth driver 42-c and an e-mail port driver 42-d for converting a print job for transmission via USB , WiFi Blue tooth and e-mail respectively.

Additionally a print by proxy driver 42-e is also provided. As noted above the provision of a set of generic printer drivers 37-a . . . 37e enables the print engine to generate print instructions for most printers. However the possibility remains that a specific printer identified by the discovery module 32 may not be supported. To allow for such a possibility, where the discovered capabilities 35 of a printer 2 indicate that the print engine 8 is not able to generate a print job for use by a printer 2, the print engine 8 is arranged to divert the document to a separate server for separate processing.

The processing of the print engine 8 will now be described with reference to FIG. 3 which is a flow diagram of the processing of undertaken by the print engine 8.

As an initial step (s1) the printer discovery module 32 performs a printer discovery operation to identify the availability, status and capabilities of printers 2 to which the mobile device 1 can send a document 3 for printing. This printer discovery operation is performed in a conventional way with the printer discovery module sending out a discovery request via the port drivers 42-a-42-d to establish what printers 2 are in the vicinity of the mobile device 1. When a discovery request is received by a printer 2, the printer 2 responds by notifying the mobile device 1 of its existence. As part of the printer discovery operation, the printer discovery module 32 also requests and obtains data defining the capabilities of the available printers 2.

The capability data 35-1-35-n is stored within the discovered data store 34. As explained previously this capability data identifies the available functionality of the discovered printers and will include data identifying for example the generic printer drivers which are compatible with a particular printer and other data such as whether the printer 2 is able to process certain file types directly together with other details of the functionality of the printer 2 for example details of fonts installed on the printer 2.

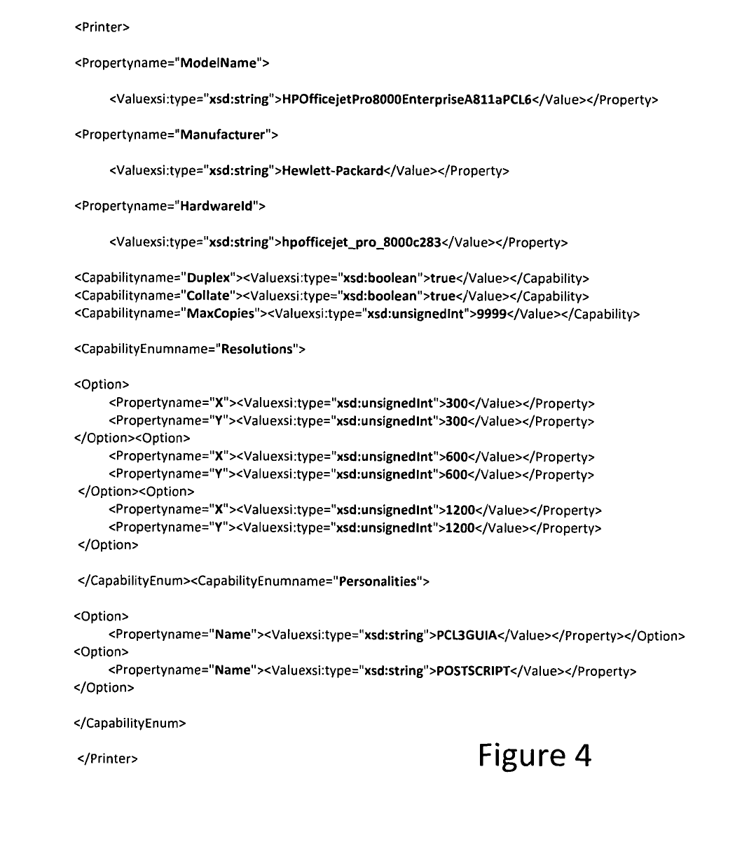

FIG. 4 is an illustrative example of a portion of an xml file detailing the capabilities of an exemplary printer. As can be seen in FIG. 4 typically data which can be obtained from a printer includes a Model Name, a Manufacturer Id and a Hardware Id which identify a specific printer type. This data is then supplemented by data which identified whether the printer can support duplex and paper collation and the maximum number of copies a printer can print as well as data defining the print resolutions available and the print languages understood by the printer.

Thus for example in the case of the illustrative example of FIG. 4 data for a Hewlett-Packard HP Office Jet Pro 8000 is shown. In the case of this printer, the printer is able to undertake duplex printing and collate pages; the printer has three print resolutions and the printer is able to understand PCL3 and Postscript printer languages.

In addition to the specific capability data which is obtained directly from a printer 3, in some embodiments certain capabilities of a printer may be derived or inferred from the obtained data. Thus for example, where a model name or hardware id is received from a printer 3, certain capabilities for the printer may be inferred by looking up the capabilities of the identified model in a database. Alternatively the printer languages a printer understands may be utilized to for example identify the fonts supported by a particular printer. Thus for example in the case of a Postscript printer fonts are grouped as standard fonts for a particular Postscript level e.g. stand Postscript level 1, 2 and 3 fonts. By identifying that a printer is supported at a particular level, it can be inferred that the printer has the capability to print using fonts included in the relevant group.

After capability data 35-1 . . . 35-n has been stored in the discovered data store 34, a user proceeds to select a document 3 for printing. More specifically, the print engine 8 causes a user interface to be generated enabling a user to select the document 3 to be printed. Such a document 3 could either be a document stored within the memory of the mobile device 1 or alternatively a document stored on a remote server 3 which has been downloaded into the memory of the mobile device 1. The document 3 to be printed is then stored (s2) in the input buffer 20 of the print engine 8.

In addition to generating a user interface enabling a user to identify a document to be printed the print engine 8 also generates a user interface enabling a user to identify a printer 2 to be utilized to print the document and to enter any formatting instructions for printing the document 3. This user interface is generated using the data stored in the capability data 35-1 . . . 35-n identifying the available printers 2 and the ability of those printers to print in particular ways e.g. simplex, duplex, color printing etc.

Having stored a document 3 in the input buffer 20, the content identifier 22 then proceeds to select (s2) a content formatter 24a . . . 24e to analyze the content of the document to generate instructions for printing. More specifically, in this embodiment a content formatter 24a . . . 24e is provided for each document type the print engine is able to process. The content identifier then assigns a document type to the document to be printed based on the file extension for the document 3 in the input buffer and selects the content formatter 24a . . . 24e associated with that document type. Thus for example if the document 3 to be processed is a Word® document, it will have a file extension .doc and the content identifier 22 would select the .doc formatter to process the document.

The identification of a content type by the content identifier 22 enables the content identifier 22 to select an appropriate content formatter 24a . . . 24e for processing the document to be printed. The document type also informs the content formatter of the syntax and layout of data within the document 3.

Thus for example if a document is determined to be an html document, not only would this enable an html formatter 24c be used to analyze and process the document 3 but such an identification would indicate that the document was formatted in a way which was compatible with the syntax of html. This means that in subsequent processing the selected content formatter 24a-24e is able to process and analyze the document 3 to identify whether the document or portions of the document 3 can be require additional processing to be printed by the select printer 2.

Another example would be a pdf document which is defined in the form of a file structure containing a number of objects and content streams. In accordance with the pdf syntax a pdf document is arranged to contain certain objects which are used to represent the document. These objects include for example pages, fonts, annotations etc. In addition the pdf syntax describes for example how a file might be encrypted at a file level to protect a document's contents from unauthorized access. A knowledge of the syntax subsequently enables the different parts of a document to be analyzed and if necessary modified.

A further example would be a png image. In accordance with the png specification a png file consists of a signature followed by a series of chunks. With a predefined knowledge of the structure, the various elements included in a png file can be identified and if necessary modified.

Having selected a content formatter 24a . . . 24e for processing the document 3, the selected content formatter 24a . . . 24e then proceeds to analyze the document to be printed and the capability data 35-1 . . . 35-n of the printer 2 to be utilized to determine how to process the document 3 to generate print instructions suitable for use by the printer 2.

As an initial step the selected content formatter 24a . . . 24e initially analyses (s4) the document 3 to determine whether to undertake any processing or whether the document 3 should be transferred straight to the processed data buffer 30 without any processing occurring. This analysis is achieved by the content formatter 24a . . . 24e utilizing the capability data 35-1 . . . 35-n to determine what types of print instructions the selected printer can handle and then analyzing the document to see whether the document 3 is already compatible with the requirements of the printer 2.

Thus for example, it is possible that the capability data 35-1 . . . 35-n for a selected printer 2 may indicate that a printer is capable of printing jpeg files. If this is the case and the content identifier 22 has identified that the document in question is a jpeg file then this would indicate that no processing is required and the unprocessed document 3 would then (s5) be transferred directly to the output buffer 40 together with data identifying the selected printer 2 and any general formatting instructions for printing the document 3 for transmission as a print job.

A more complex example would be where the capability data 35-1 . . . 35-n for a selected printer 2 indicated for example that the printer 2 in question was capable of printing certain files for example pdf files compatible with a particular version number of the pdf standard. Assuming that the content identifier 22 determined that a document to be printed was a pdf document the pdf formatter 24b would then be invoked. The pdf formatter 24b would then analyze the document to determine whether the document 3 in the input buffer was compatible with the capabilities the printer 2. This could be because the document in question was generated as a document which complied with the identified standard or an earlier compatible standard. Alternatively the pdf formatter 24b might identify that the meta-data for the document indicated that the document was created using a later standard. If this were to be the case, the pdf formatter 24b would then analyze the document in greater detail to establish whether having been created using a later standard the document nevertheless was entirely compatible with the earlier standard and hence could be passed (s5) directly to the output buffer 30 together with data identifying the selected printer 2 and any general formatting instructions for printing the document 3.

In addition to analyzing the document in the input buffer 20 to determine whether or not to process the document, the selected content formatter 24a-24e will also compare the capabilities of the selected printer 2 as identified by capability data 35-1 . . . 35-n in the discovered data store 34 to check whether the selected printer 2 is capable of understanding instructions as generated by at least one of the printer drivers 37-a . . . 37-e provided as part of the print engine 8.

As noted above the printer drivers 37-a . . . 37e can be selected so that the print engine 8 is capable of generating instructions for most printers 2. However, if the content formatter 24a . . . 24e determines that a document cannot be passed in an unmodified form direct to a printer 2 and that none of the printer drivers 37-a . . . 37-e is capable of generating a print job compatible with the printer 2 the only way in which suitable instructions can be generated will be through external remote processing. If this is the case the unmodified document is passed (s5) through to the output buffer 40 again together with data identifying the selected printer 2 and any general formatting instructions for printing the document 3.

If the selected content identifier 24a . . . 24e determines that the document 3 to be printed is not immediately suitable for being dispatched to a printer 2, the content identifier 24a . . . 24e then (s6) determines whether the document can be modified so that it can be sent for printing without substantive processing. More specifically, at this stage the content formatter 24a . . . 24e analyzing the document will have established that the selected printer 2 does not have the necessary capabilities to print the document 3 in its current form. However, it is possible that a minor modification of the document 3 might enable the document 3 to become compatible with the capabilities of the selected printer 2.

If the selected content identifier 24a . . . 24e determines (s6) that minor modifications would enable the printer 2 to print the document 2, the content identifier 24a . . . 24e then (s7) modifies those sections of the document 3 and then transmits the modified document and any global formatting instructions input via the user interface to the output buffer 40 for transmission as a print job.

Thus for example in the case of a pdf document compatible with a certain standard and a printer able to print pdf documents of a different standard, having established that the document 3 was indeed incompatible with the printer 3, the pdf formatter 24b would then analyze the portions of the document 3 which were only compatible with the higher standard and determine if those portions could be re-expressed in a manner compatible with the standard understandable by the printer 2.

Another example of processing would be where the capability data 35-1 . . . 35-n indicated that a certain font was pre-installed on a printer 2 and the document being processed was a text document. In such circumstances the .txt formatter 24e could identify that a document suitable for printing by the selected printer 2 could be generated by modifying the document to indicate that the text in question should be printed out in the selected pre-installed font. This would merely involve adding appropriate labels to the portions of text to be printed identifying that text as to be printed out in the selected font.

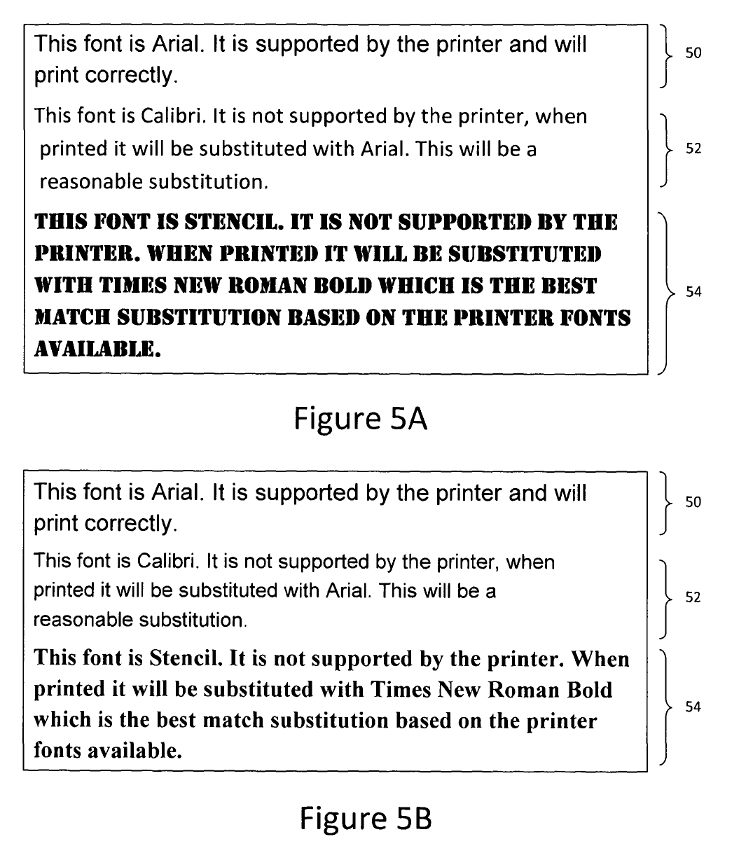

A further example of such processing is illustrated in FIGS. 5A and 5B.

FIG. 5A is an exemplary illustration of a document having three parts 50, 52, 54 which in an original document appear in three different fonts. In the illustration these three fonts are Arial, Calibri and Stencil. Typically in a word processing application such as Word® changes in font are identified by tags or makers at the beginning and end of a section of a document in a particular font style. Thus for example in the case of the illustration of FIG. 5A Arial tags would appear at the beginning and end of the first section of text 50, Calibiri tags would appear at the beginning and end of the second section of text 52 and Stencil tags would appear at the beginning and end of the final section of text 53. Such tags are not normally shown to a user but rather are utilized by the word processing application to record a change of font style.

In order to print a document such as the document illustrated in FIG. 5A, font data defining the glyph shapes and glyph metrics for the fonts appearing in the document must be available to a printer 2. Normally, however, a word processing application will only identify the font by face or family name and will not typically embed the glyph data defining glyph shapes and glyph metrics in the document 3 itself. This can cause problems when printing using a mobile device 1 as a mobile device 1 has limited storage capacity for storing font data. Additionally including such glyph data in a print job increases the volume of data which needs to be transmitted to a printer 2.

FIG. 5B is an exemplary illustration of the document of FIG. 5A rendered by a printer 2 which does not support Calibri or Stencil fonts. When analyzing a document 3, the tags present in a document 3 will indicate the fonts appearing in the original document 3. These can be compared with a list of fonts which a selected printer 2 can be established to support. If a particular font is not supported this may prevent a document from being printed. However, having identified the incompatible fonts, the incompatible font tags can be replaced with the best equivalent fonts which are available.

Thus for example in the case of the document of FIG. 5B it is assumed that the selected printer can support printing in Arial and Times New Roman. The incompatible tags for Calibri and Stencil are therefore replaced with font tags for replacement representative fonts which then renders the document into a form compatible with the selected printer. Although the overall appearance of the final document FIG. 5B differs slightly from that of the original, none of the original content of the document is omitted.

A further example would be the processing of a jpeg image. Frequently a jpeg image file will include meta-data such as data for thumbnails, color profiles, picture information and progressive encoding which is not necessary for reproducing the image on a printer. On some occasions this additional meta-data can cause a PDL interpreter on a printer to fail if the PDL interpreter is not able to understand the meta-data should be ignored. Where based on the identification of a selected printer, it is determined that such a problem is likely to occur, the meta-data can be removed from the file and the image file in the absence of the meta-data dispatched to the printer. The removal of the additional meta-data thereby renders the original image data compatible with the capabilities of the printer with the content of the image file being unaffected. In addition to facilitating processing by the printer, identifying and deleting the meta-data from the file also has an additional benefit in that the processing will reduce the overall size of the file and therefore less overhead will be required to transmit an image to the selected printer 2 for printing.

Another example would be processing a document to remove alpha channel information enabling images to be associated with certain levels of opaqueness so that one image may be rendered over another whilst the lower image still is apparent.

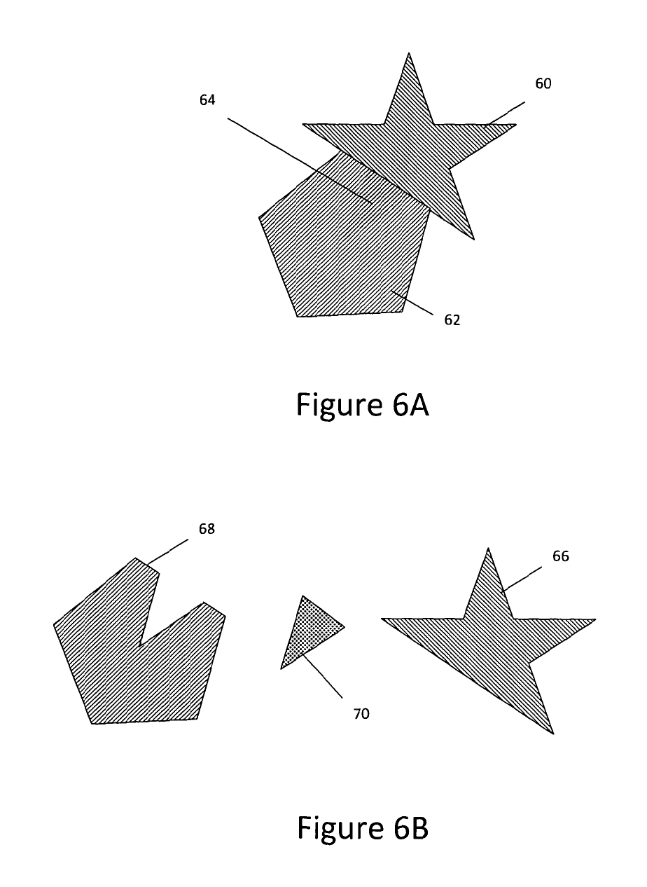

FIG. 6A is an exemplary illustration of a star 60 and a pentagon 62 where a portion 64 of the star 60 is shown as overlapping the pentagon 62. In the illustration the area of overlap 64 is shown as a blend of the rendering of the star 60 and the pentagon 62 respectively.

When represented by data defining an alpha channel each object in an image is associated with an alpha value identifying the apparent transparency of the object and color data defining the object's color. Thus for example assuming that the star 60 and pentagon 62 where to be represented as being light red and light blue respectively, the star 60 might be associated with RGB color data of the form Red=255, Green=0, Blue=0 and an alpha blending value of 0.5 and the pentagon 62 might be associated with RGB color data of the form Red=0, Green=0, Blue=255 and an alpha blending value of 0.5.

Some page description languages have no alpha capability (e.g. Postscript, PCL, XL etc). However image files e.g. png image files frequently do represent image data using alpha channel data. One approach to removing such incompatibility would be to process the alpha channel data to revise the RGB color data based on the assumption that each object was being rendered against a white background.

Thus for example in the case of the image of FIG. 6A the RGB color data and the alpha blend data for the star 60 and the pentagon 62 would be converted to RGB data representing a light red (Red=255, Green=128, Blue=128) and a light blue color (Red=128, Green=128, Blue=255) respectively. In such a conversion the modified color data would be determined by determining a weighted sum of the original color data and color data representing an assumed white background (Red=255, Green=255, Blue=255) weighted using the alpha blend data. Thus for example in the case of the star 60 in this example RGB data representing a light red (Red=255, Green=128, Blue=128) would be determined as the weighted sum of half the original color data (Red=255, Green=0, Blue=0) and half color data (Red=255, Green=255, Blue=255) representing a white background.

In many cases such an approach is an adequate simplification of image and would enable an otherwise incompatible document to be printed. Such processing alone however can introduce minor errors into a document such as in the case of the area of overlap 64 where the assumption that an object is being rendered over a white background is not necessarily appropriate as such an area will either appear in the same color as either the star 60 or the pentagon 62 depending upon the order in which the star 60 and pentagon 62 are to be rendered.

To avoid such errors arising in some embodiments complex images involving alpha channel data could be decomposed into their component parts, such as is illustrated in FIG. 6B where the image of FIG. 6A is decomposed into three shapes, a star with a missing point 66, a pentagon with a triangular section removed 68 and a triangular shaped intersection 70. RGB data for each of these shapes could then be processed using the alpha blend data and the color data for the original image elements 60, 62. In the case of the example above this would cause the star with a missing point 66, the pentagon with a triangular section removed 68 to become associated with color data representing a light red color (Red=255, Green=128, Blue=128) and a light blue color (Red=128, Green=128, Blue=255) respectively and the triangular section would become associated with a blend of the two (Red=192, Green=64, Blue=192).

Returning to FIG. 3, at this stage, the print engine 8 will have analyzed the document 3 to be printed and will have determined that:
1) The print engine 8 does have the capability to generate print instructions in a form which is understandable by the selected printer 2; and
2) The document 3 to be printed is not already in a format or which can be transmitted directly to the selected printer 2 for processing by the printer 2 itself.

This being the case, the content formatter 24a-24e then (s8) proceeds to select a first section of a document for processing. The content formatter 24a-24e then determines (s9) whether that individual section of the document 3 can be printed by the selected printer 2 without being converted into specific print instructions and if that is the case the data for that section of the document 3 is transferred (s10) direct to the processed data buffer 30 without the data being modified.

Thus for example, the html formatter 24b might identify that a particular portion of a document 3 corresponded to for example a jpeg image and the discovered capabilities for the selected printer as identified by the capability data 35-1 . . . 35-n in the discovered data store 34 indicated that such images could be printed directly by the printer 3.

If it is determined that a section of a document cannot be printed without any processing, the content formatter 24a . . . 24e, then determines whether (s11) an elementary modification of the section could enable that section to be printed without additional subsequent processing. That is to say, the content formatter 24a . . . 24e determines whether the section being processed can be converted into a printer understandable for by the addition of one or more format instructions.

If this is the case, data for that section of the document is passed (s12) to the direct graphics conversion module 25 which makes the required modifications to the original data for the document and then passes the modified data to the processed data buffer 30.

Thus for example where a content formatter 24a . . . 24e identified a portion of a document as being text and the capability data for the selected printer 2 indicated that the required font for printing out the text was already installed on the printer 2, the content formatter 24a . . . 24e might convert the section of text to be printed into a form suitable for printing by copying the data representing the text and appending a label identifying the font for printing.

If the content formatter 24a . . . 24e determines that the current section of the document cannot be modified in a minor way in order to generate instructions for printing, the selected section of the document is passed (s13) to the retained graphic conversion module 27 for processing. Typically this would occur where a section of a document corresponded to a more complex image such as a portion of a document requiring alpha blending or more generally a section of a document corresponding to an image where the selected printer 2 is unable to handle the identified image format. When a section of a document is passed to the retained graphic conversion module 27 undertakes for example rasterization, half toning and color matching etc so as to convert that section of the document 3 into a form suitable for generation of print instructions. When the processing has been undertaken the data is passed to the processed data buffer 30.

When the content formatter 24a . . . 24e has processed a particular section of the document 3, the content formatter 24a . . . 24e checks (s14) whether the final section of the document has been reached. If this is not the case, the next section of the document 3 is selected for processing (s15) and the content formatter 24a . . . 24e then determines (s9-s13) the appropriate processing for that section of the document and passes the processed data to the processed data buffer 30.

When the final section of the document 3 has been processed, the print engine 8 then (s16) proceeds to select a printer driver 37a . . . 37e to convert the data in the processed data buffer into a form understandable by the selected printer 2. This is achieved by the print engine 8 considering the discovered capability data 35-1 . . . 35-n for the printer to determine the print languages which the selected printer understands. The selected printer driver 37a . . . 37e then (s17) proceeds to process the data in the processed data buffer 30 together with any input data defining global formatting for the print job such as the number of copies to be printed, duplex and simplex printing etc and generates a print job in the format and syntax associated with the printer driver 37a . . . 37e. This generated print job is then stored in the output buffer 40.

When a print job is stored in the output buffer 40, the print engine 8 then selects (s18) a data transmission format for the print job. That is to say the print engine 8 determines the manner in which the print engine is able to communicate with the selected printer 2. Typical communication formats will depend upon the manner in which the mobile device 1 is connected to the selected printer 2 but could include USB, WiFi, Bluetooth and e-mail.

Having determined the desired communication format, the print engine 8 checks (s19) whether communication with the selected printer 2 is possible. That is to say the print engine 8 checks whether it is possible to transmit data to the selected printer 2 using the selected communication format. If this is not the case the printer 2 waits until communication is possible. Checking that communication is possible in this way means that a user is able to select a printer 2 to be used for output even if the printer is not currently within the communication range of the mobile device 1. Thus for example a user might choose to print out a document out at work when they are at home. By checking and delaying transmission of print instructions, a user can make such a selection and transmission of a print instruction is deferred until the user comes into range with the identified works printer 2 which is likely to be at a time when the user is able to access the printer 2 and pick up the output hard copy.

When it is determined that the printer 2 can be accessed the printer driver 8 invokes the port driver 42a . . . 42d associated with the selected format is invoked. The selected port driver 42a . . . 42d then converts (s20) the generated print job into data for transmission using the selected port and the print job is then transmitted to the selected printer 2 for printing.

Where the print engine 8 determines that it is not able to generate instructions for a selected printer 2 because the printer 2 cannot understand the document format of the original document 3 and the print engine 8 does not include a printer driver 37a . . . 37e compatible with the printer 2, the print engine will pass an unprocessed document and any global print formatting instructions direct to the output buffer 40 where it is transmitted to a remote server for remote processing. In this embodiment this is achieved by the print by proxy module 42e which is invoked in a similar way to the other port drivers 42a . . . 42d.

Although in the above embodiment, a system has been described in which the file name extension for a document is utilized to identify the structure and content of a document to be printed, it will be appreciated that other approaches could be used. More specifically the content of a document itself could be analyzed directly to determine the document's structure and syntax for subsequent processing. Such an approach would have the advantage that it would be possible to determine a document's structure and syntax even if a file extension associated with the document was incorrect of corrupted. In some embodiments the structure and syntax of a document could be determined by analysis and then confirmed utilizing the file extension associated with the document or vice versa.

In the above described embodiment a system has been described where a printer discovery module 32 obtains capability data 35-1; . . . ; 35-n directly from a printer 2. Examples of such conventional discovery operations which would enable such data to be obtained would mDNS (Multicast Domain Name System), SSDP (Simple Service Discovery Protocol) and WSD for network printing. In such embodiments data would be obtained directly from the printer 2 using a conventional protocol such as SNMP (Simple Network Management Protocol).

In some embodiments rather than obtaining capability data 35-1; . . . ; 35-n direct from the printer 2, an alternative approach would be just to obtain data indicating the identity of the printer 2 from the printer 2 e.g. printer model and printer type. The print engine 8 could then access a stored data base of capability data indicating the relevant capabilities of that type of printer. The advantage of such an approach would be that it would provide a way to obtain relevant capability data for a printer even when such information was not provided by a printer directly through the discovery operation. Additionally having a specific store of data associating printer types with capability data provides a means by which the accuracy of such data can be controlled as the applicants have determined that capability data received directly from printers can often be inaccurate or out of date. A suitable database could be provided either as part of the print engine 8 on a mobile device 1 or alternatively as a separate database on a remote server 4.

Although in the above embodiments processing of documents containing alpha channel data has been described as taking place when a printer 2 is unable to process alpha channel data, in some embodiments it may be desirable to undertake such opacity flattening to replace alpha channel data with revised color data even if a printer 2 has some capability to process a document 3. In particular where a document can be analyzed to determine that it contains complex alpha channel data applying to multiple image components, processing such documents can strain the memory capabilities of some printing devices. This can lead to poor performance or at worst failed rendering. By identifying the capabilities of the printer in advance, a decision can be made as to whether this is likely to occur and if so where the processing of an image is likely to stretch a selected printing device, the printing device can be treated as lacking a capability to handle the processing and a document can be pre-processed by the mobile device to remove the potential incompatibility.

Although in the above embodiment, a print engine 8 has been described which is capable of processing five document types (Word ® documents, pdf documents, html documents, txt documents and jpeg documents), it will be appreciated that other content formatters 24a-24e could be provided. Thus for example in addition to the above content formatters 24a-24e could be provided to interpret and process for example other word processing formats such as Open Office® XML documents, spreadsheet formats such as Excel® or Open XML spread sheets and presentation formats such as PowerPoint® or Open Office presentations. In addition to jpeg images formatters could be provided to process other common image formats such as png, tiff and gif images.

Similarly convertors could be provided to process other data types frequently found on mobile devices such as rfc822 e-mail messages, V-card or Android contacts and calendar entries to enable such data to be printed. In the case of such data typically some kind of text data is embedded within a larger data file. When processing such data such a formatter may be arranged to extract the text data included in the document and include the extracted text in a template containing other data.

Thus for example in the case of an e-mail message, text data for the from, to, sent, subject and message fields of an e-mail might be extracted and then processed by being combined with formatting data setting the extracted data out in a particular way on a page. Such processing could include adding appropriate headings e.g. “From:”, “To:”, “Sent:”, etc. in front of the extracted items of data. In some embodiments the print engine 8 might be arranged to determine the headings to be utilized based on other settings on a mobile device 1 such as the device's default language. Thus for example where a mobile device 1 was set to utilize say German or Japanese as a language, the appended heading could be replaced with equivalent text in that language.

Although in the above described embodiment, a system has been described where a print engine 8 is installed on a mobile device 1, such as a cellular phone or laptop computer or a PDA it will be appreciated that the described print engine 8 could be installed on a computer such as a desktop computer normally utilized in a fixed place. In such an embodiment, the described system would provide the computer with the facility to print documents on printers 2 where the computer did not already have a particular printer driver for a particular printer type installed.

In the embodiment described in detail, a mobile device 1 is described as providing print data either directly to a printer 2 or in the case of a print by proxy indirectly to a printer 2. It will be appreciated that where printers 2 and computers are connected via networks more complex routings become possible. Thus for example, in some embodiments, rather than communicating to a printer 2 directly a mobile device 1 might communicate with a printer 2 via an intermediary computer.

In such embodiments, rather than obtaining data relating to the capabilities of a printer 2, a print engine 8 might determine the capabilities of the combined capabilities of the printer 2 and the intermediary computer. In such an embodiment, if an intermediary computer had the ability to process pdf documents, say for example because the computer had Abode Acrobat® installed and the intermediary computer also had a printer driver for generating print instructions for a particular printer 2, the print engine 8 might obtain or derive information indicating that the connected printer 2 was able to process pdf documents because the combination of applications installed on the intermediate computer had the facility to process pdf documents and convert such documents into print instruction for that printer 2.

In some embodiments indirect communication with a printer may be facilitated by a cloud printing service. In such a service a printer or a computer connected to a printer registers with a cloud printing service. When a user wishes to print from a mobile device 1 using the cloud printing service, the mobile device 1 obtains information about the capabilities of a registered printer via the cloud printing service. When a print job has been formatted the print data is formatted by a port driver for the cloud printing service which causes the print job to be forwarded to a selected printer.

In some embodiments, it may be possible that a mobile device 1 is able to communicate with a particular printer in a number of different ways e.g. directly via a Bluetooth connection or indirectly via a server or some other network connection. If a mobile device is able to determine that multiple routes are available to send data to a printer 2, a preferred routing may be determined when data is to be dispatched. The preferred routing may be selected on the basis of the overhead required to format and sent data for a print job to a printer via the different routes. Thus for example, if it was apparent to a mobile device 1 that a selected printer 2 was available for use via a wired and a wireless connection the mobile device 1 might be arranged to prefer use of the wired connection. In such embodiments some kind of identifier might be obtained from a printer to facilitate identification of the existence of different routings as being routings to the same machine.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source or object code or in any other form suitable for use in the implementation of the processes according to the invention. The carrier could be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When a program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. A method of generating a print job for a printer, the method comprising:
determining the capabilities of the printer for which a print job is to be generated, wherein said capabilities define file and instruction formats which can be printed by the printer; and
pre-processing a document defining data for which a print job is to be generated by:
analyzing the document to determine whether the document is in a format compatible with the capabilities of the printer and if so passing the unprocessed document to the printer;
if the document is not in a format compatible with the capabilities of the printer, determining whether the document can be modified to remove incompatibilities between the format of the document and a format compatible with the capabilities of the printer without removing content from the document and if so making the determined modifications and passing the processed document to the printer; and
if a document is not in a format compatible with the capabilities of the printer and cannot be modified without changing the content of the document to become compatible with the capabilities of the printer, processing the document to generate print instructions compatible with the printer for representing the document and passing the generated instructions to the printer.

2. The method of claim 1 wherein determining the capabilities of the printer for which a print job is to be generated comprises:
performing a discovery operation to identify one or more available printers; and
obtaining capability data defining the capabilities of the printers discovered to be available.

3. The method of claim 2 wherein obtaining capability data comprises utilizing data obtained during the discovery operation to identify the type of printers available; and
accessing a database associating printer types with capability data.

4. The method of claim 2 wherein said capability data comprises data defining any of: printer languages understood by the printer; document formats understandable by a printer; document format versions understandable by a printer; duplex capabilities;
collation capabilities, supported paper sizes, printer output media supported, media path information, input trays, output trays and font data installed on a printer.

5. The method of claim 4 wherein said printer languages comprise any language selected from the group comprising: PostScript, Printer Command Language, Epson Standard Code for Printers, Refined Printing Command Stream; Ricoh Printer driver language, XML Paper Specification, ZJ stream, Canon Printing System Language, Xerox Escape Sequences, and XHTML-Print.

6. The method of claim 4 wherein said document formats comprise one or more document formats selected from the group comprising: Word Document format, Open Office word processing format, Excel format, Open Office spreadsheet format, Power point format, Open Office presentation format, jpeg format, png format, tiff format, gif format, e-mail message format, v-card contact format, android contact format, calendar entry format, pdf format, html format and text format.

7. The method of claim 2 wherein analyzing a document to determine whether the data is in a format compatible with the capabilities of the printer comprises:
identifying a file extension associated with a document to printed to determine the format of the document and comparing the identified format with capability data for the printer identifying file formats compatible with the printer.

8. The method of claim 7 wherein analyzing a document to determine whether the data is in a format compatible with the capabilities of the printer comprises:
utilizing the file extension associated with a document to determine the structure and syntax of document to be processed;
using the determined structure and syntax to analyze the document to determine whether the document is compatible with a format version identified by capability data as compatible with a printer to be utilized to print the document; and
if a document is not compatible with a format version identified by capability data, analyzing the portions of the document which are not compatible with the identified format version and replacing the incompatible portions of the document with data compatible with the format version identified by the compatibility data where the replacement of data does not change the content of the document as printed by the printer.

9. The method of claim 8 further comprising:
if a document is not compatible with capability data for a printer, using the determined structure and syntax to analyze the document to determine portions of the document which are compatible with the capability data for a printer and passing data corresponding to the portions of a document identified as compatible with the capabilities of a printer without additional processing.

10. The method of claim 8 further comprising:
if a document is not compatible with capability data for a printer, using the determined structure and syntax to analyze the document to determine portions of the document which correspond to images in a format identified as compatible with the capability data for a printer and passing data corresponding to the portions of a document identified as compatible with the capabilities of a printer without additional processing.

11. The method of claim 8 further comprising:
if a document is not compatible with capability data for a printer, using the determined structure and syntax to analyze the document to determine portions of the document which correspond to text in a format identified as compatible with the capability data for a printer and passing data corresponding to the portions of a document identified as compatible with the capabilities of a printer without additional processing.

12. The method of claim 11 further comprising:
selecting a font for printing portions of a document identified as being text on the basis of capability data indicating fonts installed on the printer to be utilized to print the document.

13. The method of claim 1, further comprising:
if a document is not in a format identified as being compatible with a printer and if the document cannot be processed to become compatible with the printer:
identifying a printer language compatible with the printer;
selecting a printer driver to convert the pre-processed document into print instructions on the basis of the identified printer language;
converting the pre-processed document using the selected printer driver to generate print instructions in the selected printer language; and
outputting the generated print instructions.

14. The method of claim 1 wherein processing the document to generate print instructions compatible with the printer for representing the document comprises determining whether print instructions compatible with the determined capabilities for a printer can be generated locally and if not sending the document for processing on a remote server.

15. A print engine comprising:
a discovery module operable to determine the capabilities of a printer for which a print job is to be generated, wherein said capabilities define file and instruction formats which can be printed by the printer; and
a content formatter operable to process a document defining data for which a print job is to be generated by:
analyzing the document to determine whether the document is in a format compatible with the capabilities of the printer and if so passing the unprocessed document to the printer;
if the document is not in a format compatible with the capabilities of the printer, determining whether the document can be modified to remove incompatibilities between the format of the document and a format compatible with the capabilities of the printer without removing content from the document and if so making the determined modifications and passing the processed document to the printer; and
if a document is not in a format compatible with the capabilities of the printer and cannot be modified without changing the content of the document to become compatible with the capabilities of the printer, processing the document to generate print instructions compatible with the printer for representing the document and passing the generated instructions to the printer.

16. A print engine in accordance with claim 15 further comprising a content identifier operable to identify a file extension associated with a document to printed wherein the content formatter comprises a plurality of content formatters each associated with a different file type wherein the print engine is operable to select a content formatter for processing a document to be processed on the basis of the file type identified by the content identifier.

17. A print engine in accordance with claim 15 wherein each of the plurality of content formatters are configured to process documents having the file type associated with that content formatter and analyze the document to determine whether the document is compatible with a format version identified by capability data as compatible with a printer to be utilized to print the document; and if a document is not compatible with a format version identified by capability data, analyze the portions of the document which are not compatible with the identified format version and replace the incompatible portions of the document with data compatible with the format version identified by the compatibility data where the replacement of data does not change the content of the document as printed by the printer.

18. A print engine in accordance with claim 17 wherein each of the plurality of content analyzers is operable if a document is not compatible with capability data for a printer, to analyze a document of the file type associated with the content formatter to determine portions of the document which are compatible with the capability data for a printer and pass data corresponding to the portions of a document identified as compatible with the capabilities of a printer without additional processing.

19. A print engine in accordance with claim 18 wherein each of the plurality of content analyzers is operable if a document is not compatible with capability data for a printer to determine portions of the document which correspond to images in a format identified as compatible with the capability data for a printer and pass data corresponding to the portions of a document identified as compatible with the capabilities of a printer without additional processing.

20. A print engine in accordance with claim 18 wherein each of the plurality of content analyzers is operable if a document is not compatible with capability data for a printer, document to determine portions of the document which correspond to text in a format identified as compatible with the capability data for a printer and pass data corresponding to the portions of a document identified as compatible with the capabilities of a printer without additional processing.

21. A print engine in accordance with claim 15 wherein the content formatter is operable to selecting a font for printing portions of a document identified as being text on the basis of capability data indicating fonts installed on the printer to be utilized to print the document.

22. A print engine in accordance with claim 15 further comprising a plurality of printer drivers operable to convert processed documents into print instructions in specific printer languages.

23. A print engine in accordance with claim 22 wherein the print engine is operable to determine on the basis of capabilities of a printer identified by the discovery module whether any of the plurality of printer drivers is operable to generate print instructions compatible with the printer and select a printer driver to generate print instructions on the basis of said determination wherein if the print engine determines that print instructions compatible with the determined capabilities for a printer cannot be generated by the print engine, the print engine is operable to send a document for processing on a remote server.

24. A computer readable medium storing computer interpretable instructions which when interpreted by a programmable computer cause the computer to :
determine the capabilities of a printer for which a print job is to be generated, wherein said capabilities define file and instruction formats which can be printed by the printer; and
pre-processing a document defining data for which a print job is to be generated by:
analyzing the document to determine whether the document is in a format compatible with the capabilities of the printer and if so passing the unprocessed document to the printer;
if the document is not in a format compatible with the capabilities of the printer, determining whether the document can be modified to remove incompatibilities between the format of the document and a format compatible with the capabilities of the printer without removing content from the document and if so making the determined modifications and passing the processed document to the printer; and
if a document is not in a format compatible with the capabilities of the printer and cannot be modified without changing the content of the document to become compatible with the capabilities of the printer, processing the document to generate print instructions compatible with the printer for representing the document and passing the generated instructions to the printer.
